(19) United States
(12) Patent Application Publication
(10) Pub. No.: US 2009/0301144 A1
(43) Pub. Date: Dec. 10, 2009

(54) LOCK MASTER KEYING EVALUATION SYSTEM AND METHOD

(75) Inventor: Mark Alan Herman, Bexley, OH (US)

Correspondence Address: RATNERPRESTIA, P.O. BOX 980, VALLEY FORGE, PA, 19482, US

(73) Assignee: Ingersoll-Rand Company, Montvale, NJ (US)

(21) Appl. No.: 12/134,549

(22) Filed: Jun. 6, 2008

(51) Int. Cl. E05B 15/00

(52) U.S. Cl. 70/1

(57) ABSTRACT

A method of evaluating a master key system. The method comprises entering criteria for the master key system and determining the available master key cuts and change key cuts based on the criteria. The determined available master key cuts and change key cuts are arranged under a standard progression format including at least two page masters. Each page master is displayed as a graphical page master arranged graphically relative to the other graphical page masters based on the master key hierarchy. The information is displayed as a master key illustrator.

### BACKGROUND OF THE INVENTION

This invention relates generally to master key systems and more particularly to a method of assigning change keys and master keys for a master key system.

One of the most common requests seen on orders for new master key systems is to “provide for maximum expansion”. The customer makes this request to extend the life of the newly purchased master key system. Unfortunately the term “maximum expansion” is completely meaningless. The expansion potential of a key system is defined by the mechanical characteristics of the cylinder. There is no way to configure a system to exceed those characteristics, and there are several ways to allocate the expansion inherent in them. No single expansion configuration is optimal for every facility and none of them will accommodate every possible future event.

The most effective strategy to prevent the early replacement of a key system is to: plan it using prudent budgeting techniques; implement it using effective project management; and protect it with sound key control practices.

A system that is not correctly planned and budgeted is doomed to failure from the start. While this first step is essential, it is often shortchanged because the people in the best position to contribute have the least understanding of cylinder mechanics and the mathematics of master keying. To facilitate good planning in the key system design phase, a tool is needed which would allow those people to participate in the process effectively.

Planning tools are paradigms that allow users to understand keying issues without having to understand locks. One such tool is the popular “dividing the key” paradigm. An example of the use of this tool would be to say that in a six pin grand master key system you were using “two pins for masters and four pins for changes.” That would yield (in a traditional Schlage lock style system) 16 masters of 256 changes each. The same expansion could have been allocated differently using, for example, “three pins for masters and three pins for changes” or “one pin for masters and five pins for changes.” Dividing the key is a very useful tool that allows rapid analysis of user requirements. However, it paints in too broad a stroke to be used for complex systems.

The foregoing illustrates limitations known to exist in present master keying systems. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

In one aspect, the invention relates to a method of evaluating a master key system. The method comprises entering criteria for the master key system and determining the available master key cuts and change key cuts based on the criteria. The determined available master key cuts and change key cuts are arranged under a standard progression format including at least two page masters. Each page master is displayed as a graphical page master arranged graphically relative to the other graphical page masters based on the master key hierarchy.

In another aspect, the invention relates to a master key illustrator for illustrating the available master key cuts and change key cuts under a master key system. The illustrator comprises at least first and second graphical page masters. Each graphical page master is representative of a respective group of master key cuts and change key cuts available under the master key system. The graphical page masters are arranged graphically relative to the other graphical page masters based on the master key hierarchy.

The foregoing and other aspects will become apparent from the following detailed description of the invention when considered in conjunction with the accompanying drawing figures.

### BRIEF DESCRIPTION OF THE DRAWINGS

FIGS. 1A through 1C show a typical pin tumbler cylinder;

FIGS. 1D and 1E show a typical master keyed pin tumbler cylinder;

FIG. 2 shows a sample key system schematic;

FIG. 3 illustrates an exemplary key bitting array;

FIG. 4 is an illustrative page master listing of all key bitting combinations generated by the bitting list generator for a given page master key;

FIG. 5 is an illustrative master key illustrator showing graphically the master key system for the given key bitting array;

FIG. 6 is an expanded view of the upper left quadrant of the master key illustrator of FIG. 5; and

FIG. 7 is an expanded view of the lower left quadrant of the master key illustrator of FIG. 5.

### DETAILED DESCRIPTION OF THE INVENTION

The following are definitions of a few common master keying terms:

Master key system is any keying arrangement that has two or more levels of keying.

Change key is a key that operates only one cylinder or one group of keyed alike cylinders in a keying system.

Bitting is the number(s) which represent the dimensions of the key cut(s) on a key.

Key bitting array is a matrix (graphic) display of all possible bittings for change keys and master keys as related to the top master key.

Levels of keying are the divisions of a master key system into hierarchies of access. Level 1 is the lowest level and consists only of change keys. The highest level is the top master key that operates all locks in the master key system.

MACS is maximum adjacent cut specification, or the maximum allowable difference between adjacent cut depths.

Cross keying is the deliberate process of combinating a cylinder (usually in a master key system) to two or more different keys which would not normally be expected to operate it together.

Master key is a key which operates all the master keyed locks or cylinders in a group, each lock or cylinder usually being operated by its own change key.

Page master key is the master key for all combinations listed on a page in the standard progression format.

Block master key is the master key for all combinations listed as a block in the standard progression format.

Horizontal group master key is the master key for all combinations listed in all blocks in a line across the page in the standard progression format.

Vertical group master key is the master key for all combinations listed in all blocks in a line down a page in the standard progression format.

Row master key is the master key for all combinations listed on the same line across a page in the standard progression format.

Grand master key is a key which operates two or more separate groups of locks, which are each operated by a different master key.

Sequence of progression is the order in which bitting positions are progressed to obtain change key combinations, typically either a 1 step, using a one increment difference between bittings of a given position, or 2 step progression, using a two increment difference between bittings of a given position.

Standard progression format is a systematic method of listing and relating all change key combinations to all master key combinations in a master key system. The listing is divided into segments known as blocks, horizontal groups, vertical groups, rows, and pages, for levels of control.

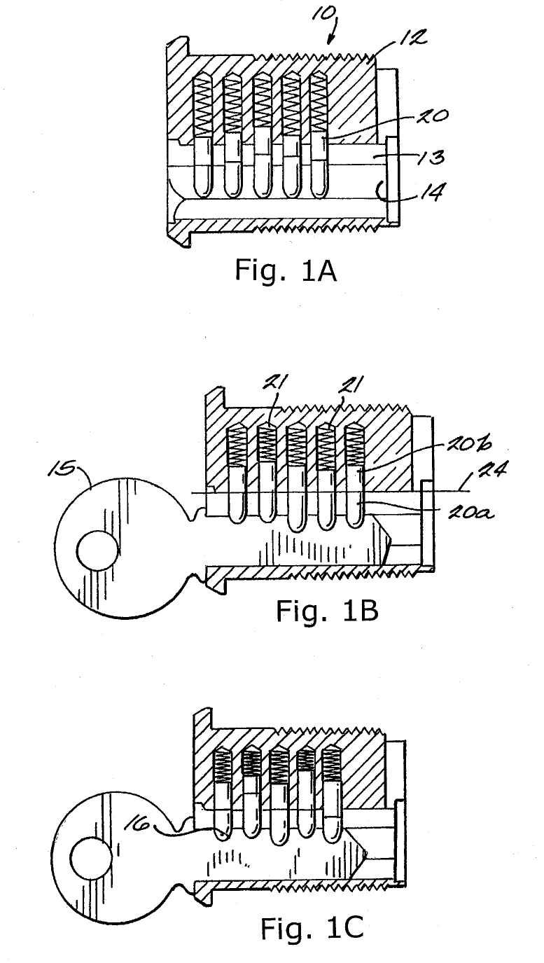

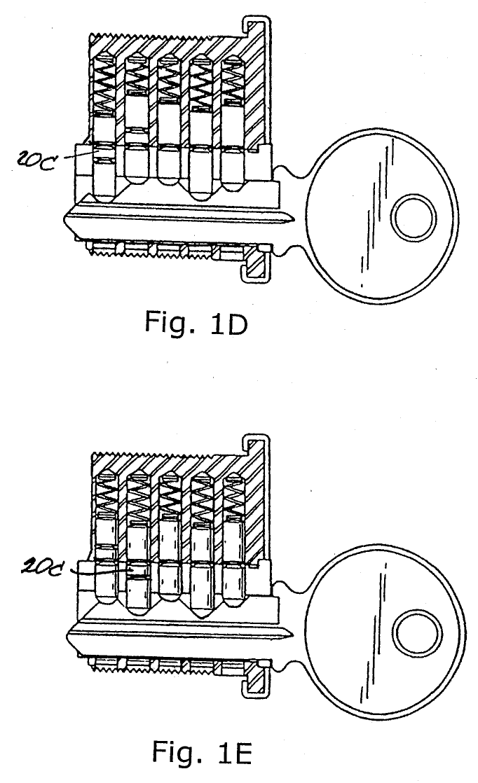

FIGS. 1A through 1C show a typical pin tumbler cylinder 10. The cylinder 10 consists of a shell 12 having a rotatable plug 13 within. The plug 13 has an axially extending keyway 14, which accepts key 15. A series of cuts 16 are placed on the upper edge of key 15. Within the shell 12 and plug 13 are a plurality of pins 20 and springs 21. Pins 20 are comprised of at least two segments, a bottom pin 20a and a top pin or driver 20b. When a cylinder has been pinned for master keying, one or more master pins 20c (see FIGS. 1D and 1E) are used in each pin stack. The depths of the cuts 16 on the key 15 are called bittings and typically are numbered from 0 to 9. With no key 15 inserted in the cylinder 10, the top pins 20b and bottom pins 20a are forced by the springs 21 down into the plug 13. The top pins 20b are then partially in the shell 12 and partially in the plug 13, forming an obstacle that keep the plug 13 from turning, as shown in FIG. 1A. When a proper key 15 is inserted into the cylinder 10, the bitting depth of the cuts 16 brings the top of each of the bottom pins 20a exactly to the surface of the plug 13, forming a shear line 24, as shown in FIG. 1B. With the tops of the bottom pins 20a aligned with the shear line 24, the key 15 and the plug 13 can be turned. When an incorrect key 15 is inserted, one or more of the top and bottom pins 20b, 20a will not align with the shell 12 surface to form the shear line 24, thereby preventing rotation of the key 15 and plug 13, as shown in FIG. 1C.

FIGS. 1D and 1E illustrate a typical cylinder 10 which has been pinned for master keying. The term “master keyed” usually denotes that each individual cylinder is operated by two or more different keys. The key that normally opens only one cylinder or keyed alike group of cylinders is called a change key. The key that opens all the cylinders in a group or series is called a master key. An example of a simple master key system would be in a small office building. There would be an individual change key for each office door, and there would be a master key to operate all office doors. The essential difference between an ordinary pin tumbler cylinder and a master keyed cylinder is the use of master pins 20c. A master pin is an additional top pin, usually shorter, which is inserted between the bottom pin 20a and the top pin 20b. In each pin chamber where a master pin 20c is located, a second shear position is created. The cylinder can be operated at either shear position. Thus, different key bittings can be used for each position where there is a master pin. FIG. 1D shows a master keyed cylinder 10 with a change key 15 inserted and FIG. 1E shows the same master keyed cylinder 10 with a master key 15 inserted. In both figures, the pins 20 have aligned to form a shear line 24, thereby permitting the key 15 and plug 13 to rotate.

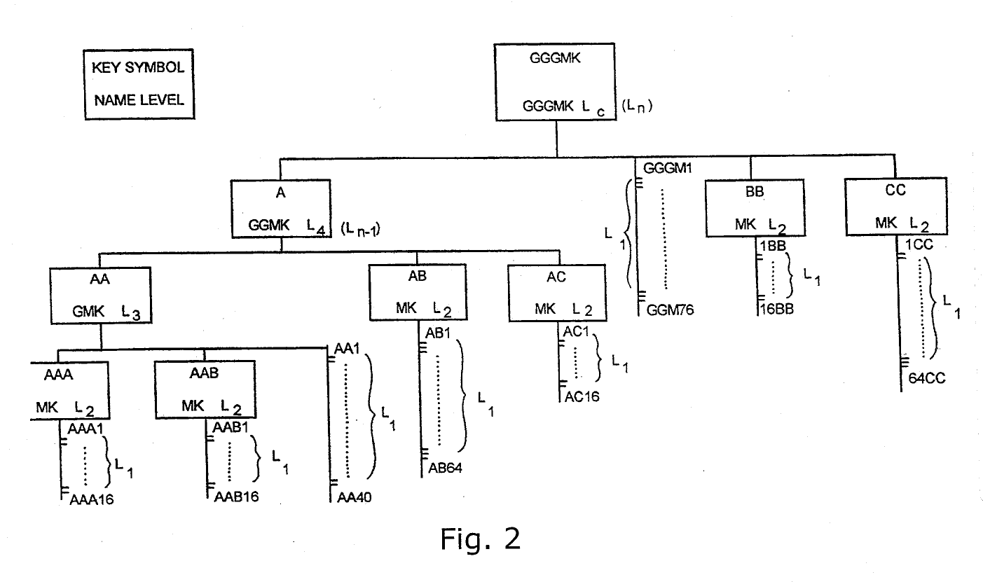

FIG. 2 shows a key system schematic for a five level system of change keys and master keys. The levels are numbered from 1 (L₁), the lowest level and which is assigned to the change keys, to the highest level n (L₅ in FIG. 2) which consists of the master key which will operate all the locks in the system. The first level below level Lₙ is assigned a key symbol of A, B, . . . , Z. (However, if the master key below level Lₙ has no master keys below it, key symbols of AA, BB, . . . , ZZ are used.) The next level below is AA, AB, . . . , AZ for master keys below A and AAA, AAB, . . . , AAZ for master keys below AA. Change keys are always level L₁ and have a key symbol the same as the master key with which they are grouped followed by a number. In FIG. 2, there are 16 change keys grouped under master key AAA having key symbols, AAA1, AAA2, . . . , AAA16. The first level above the change keys are named Master Keys (MK). The highest level master key is named based upon the number of levels in key system schematic, even if it is also a first level master key above a group of change keys. In the example shown in FIG. 2, a five level system, the top level (L₅) master key is named Great Great Grand Master Key (GGGMK). Intermediate level master keys are named according to the number of levels below them. Master Keys AAA and AAB are Level L₂. Master key AA, level L₃, is named Grand Master Key (GMK). Master keys AB and AC, BB, CC are named Master Keys and are level L₂ since they are the first master keys above change keys. Master key A is a Great Grand Master Key (GGMK) and is level L₄.

To determine the available master keys and change keys for a given master key system, the present invention utilizes a bitting list generator to calculate all of the available key cuts for the system. The bitting list generator is preferably a computer operated system which starts with a key bitting array (KBA) 30 and calculates all of the available key cuts based on the intended sequence of progression (SOP). An acceptable bitting list generator is a spreadsheet which is configured to calculate each key cut based on the KBA 30 and SOP and to eliminate any cuts which violate the MACS. Any other system capable of performing the necessary calculations and coordination of data may alternatively be utilized.

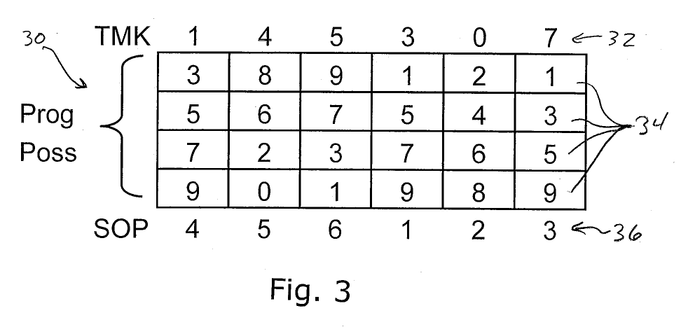

An illustrative KBA 30 is shown in FIG. 3. A user enters a desired KBA 30 into the bitting list generator following general master keying rules and the intended SOP. In the illustrated KBA 30, the user begins by entering the top master key (TMK) cut sequence 32. The user will then check the KBA 30 to be sure the necessary sequencing rules have been adhered to, for example, there are no digits from the TMK 32 in the Progression Possibilities 34, that the Progression Possibilities 34 increment by two digits and are all odd or even digits depending on system parity, and that the SOP 36 uses digits 1-6 and they do not reoccur. These are the requirements for this given master key system, but each master key system can have its own requirements in accordance with known master keying principals.

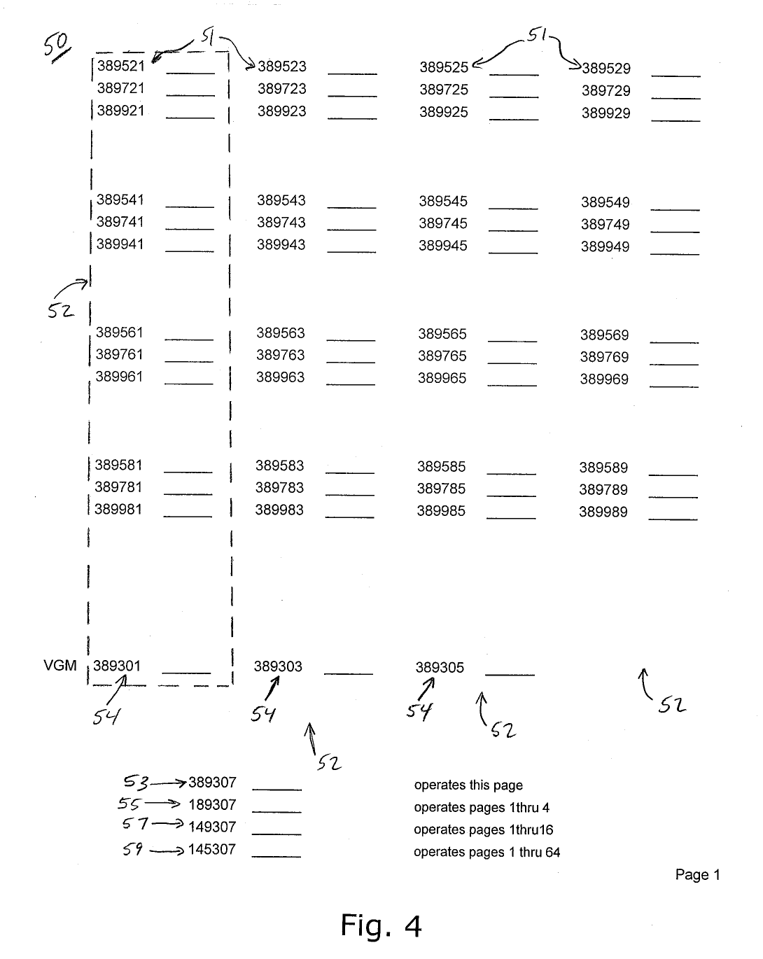

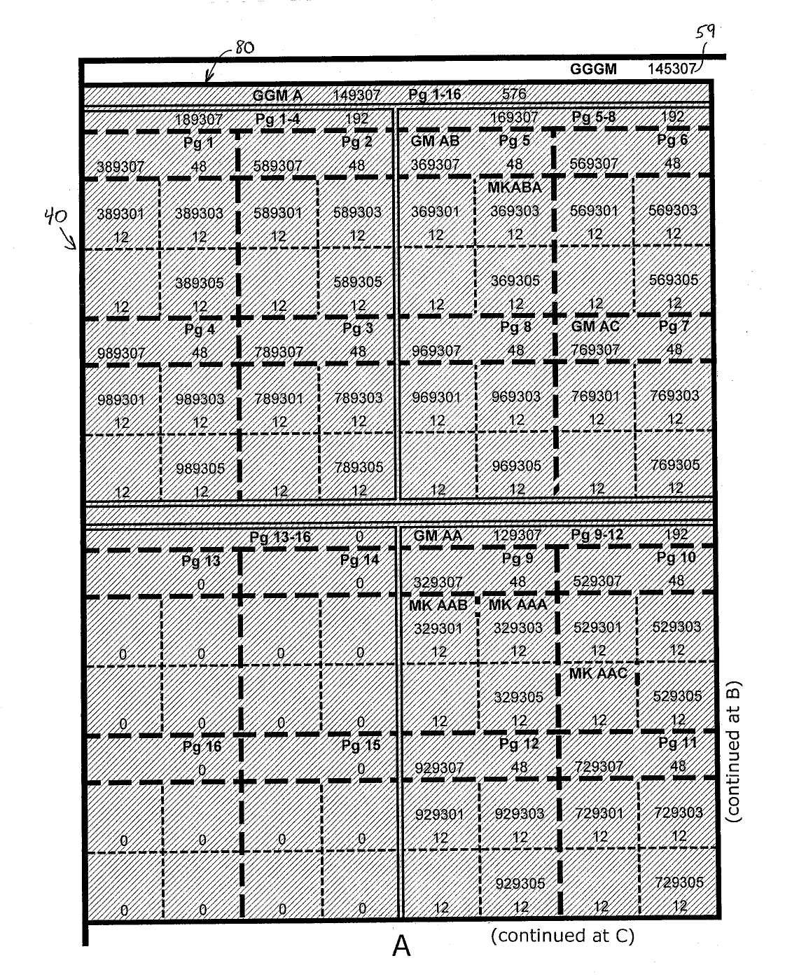

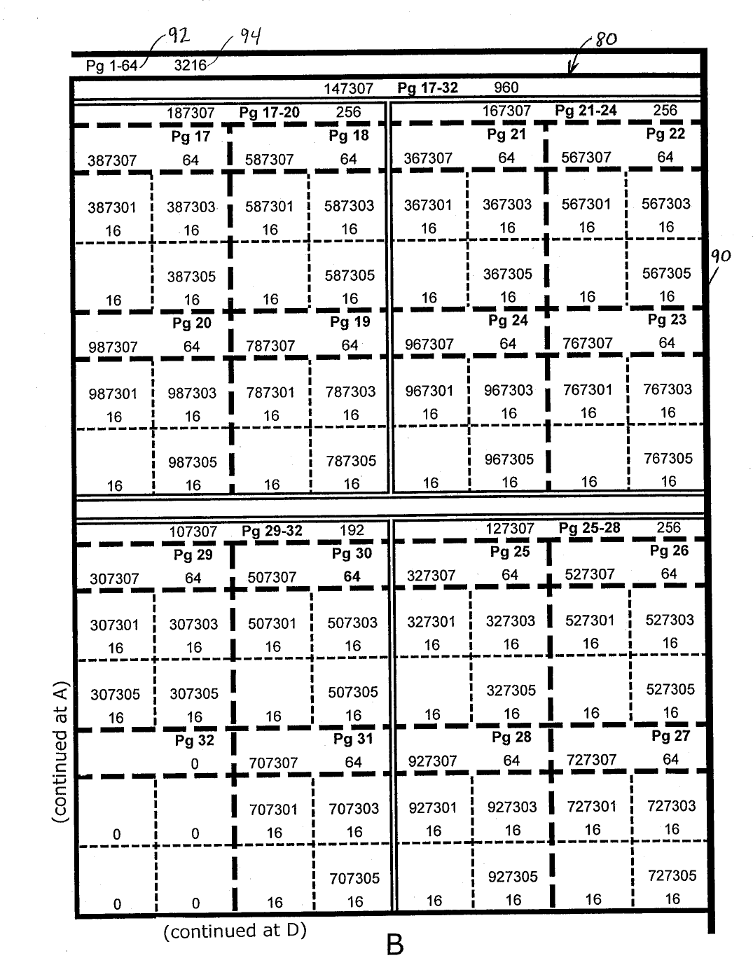

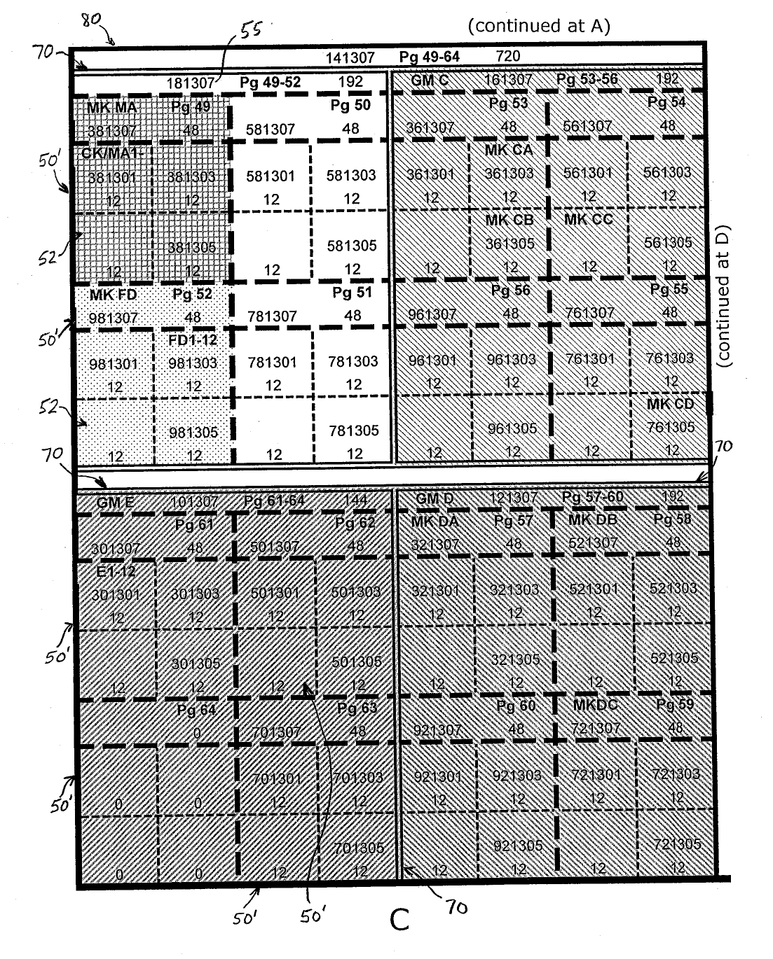

Once the KBA 30 has been entered, the bitting list generator calculates and outputs all of the available key cuts and master key combinations using a standard progression format. For example, the standard progression format may list the available key cuts divided into segments known as blocks, horizontal groups, vertical groups, rows, and pages, for levels of control. Referring to FIG. 4, an illustrative page master 50 for the KBA 30 of FIG. 3 is shown. The page master 50 includes each change key cut 51 that is available under the page master key cut 53. Additional master key cuts may also be available for the given page master 50. For example, there may be a master key cut 54 for each vertical group 52. In the illustrated embodiment, each of the first three vertical groups 52 has a respective master key cut 54, but the fourth vertical group 52 does not have an available master key cut. In each vertical group 52 of this illustrated page master 50, twelve change key cuts 51 are available. This means that four cuts in each of these rows violates the MACS, and therefore, is not listed as an available change key cut.

The page master 50 also shows higher level master key cuts, for example, a master key cut 55 that will operate all of the key cuts on page master 50 for page one as well as page masters 50 for pages two through four. Another master key cut 57 operates all of the key cuts on page master 50 for page one as well as page masters 50 for pages two through sixteen. A third master key cut 59, for the TMK, operates all of the key cuts on page master 50 for page one as well as page masters 50 for pages two through sixty-four. With this single page master 50, a user would be able to create a six level master key system with the change key cuts 51 as L₁, the vertical group master key cuts as L₂, the page master key cut 53 as L₃, the page one through four master key cut as L₄, the page one through sixteen master key cut as L₅, and the TMK master key cut as L₆.

The current KBA and the SOP are utilized with a cylinder having 6 pins which are all used for master keying. Under such a system, the bitting list generator will generate sixty-four page masters 50. The number of page masters 50 will vary depending upon the set up of the cylinder and the configuration of the standard progression format. More or fewer page masters 50 may be generated as well as the particular number and arrangement of segments on each page master 50.

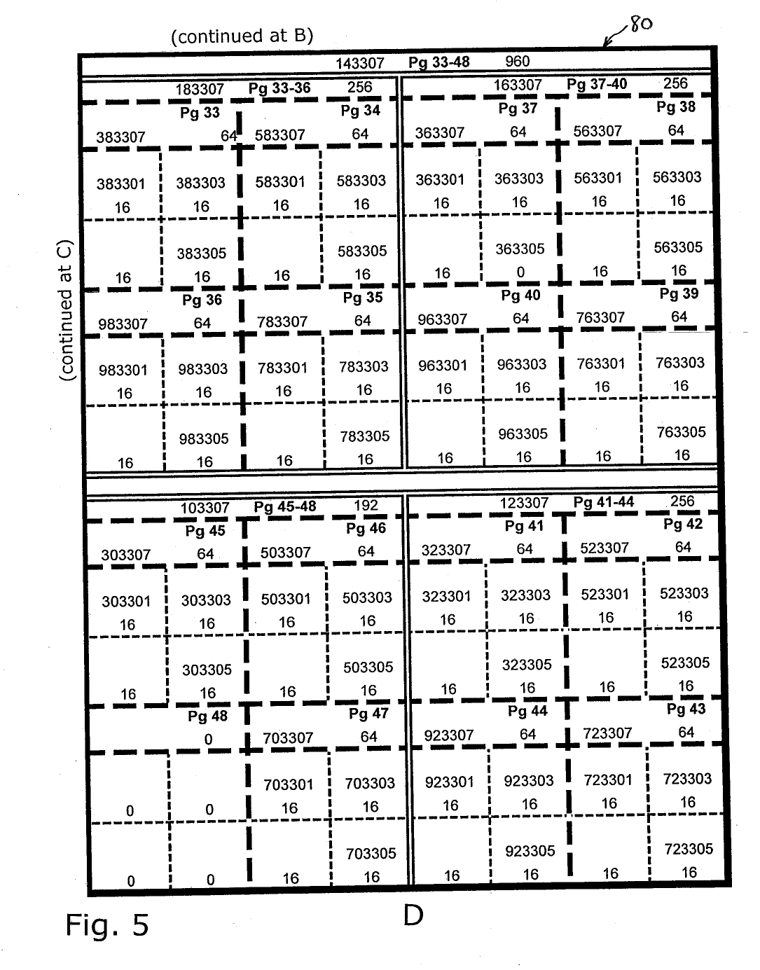

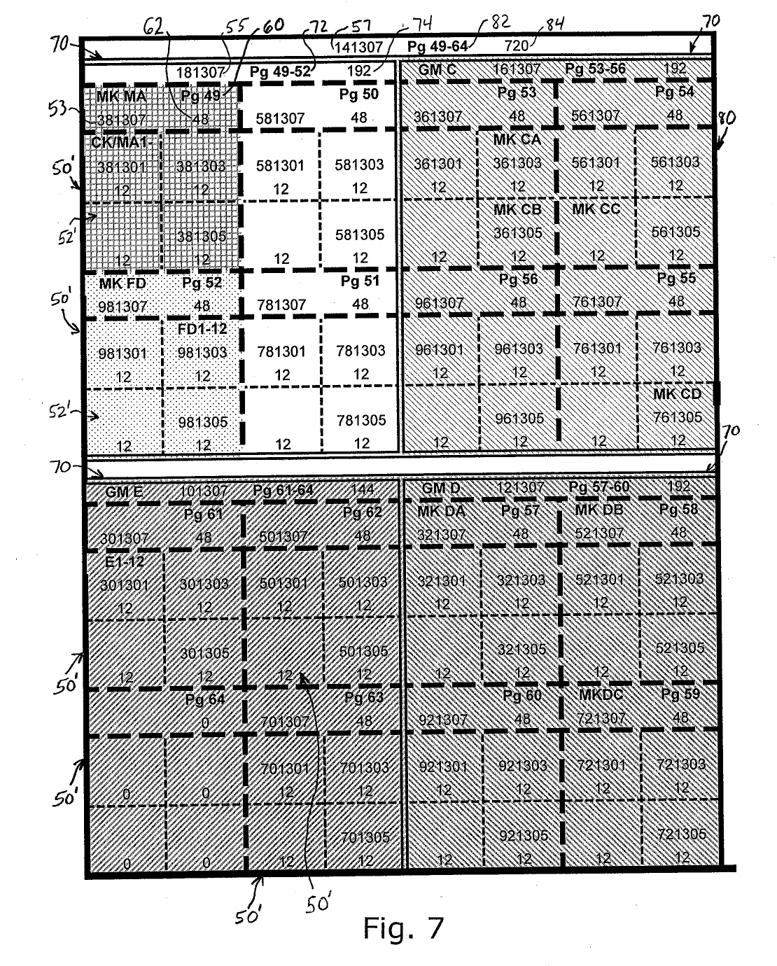

To allow an operator to visually see and understand how many master key cuts and change key cuts are available under a given master key system, the present invention further generates a master key illustrator 40 as shown in FIGS. 5-7. The master key illustrator 40 shows all page masters 50 of the given master key system graphically and interrelated to one another. Turning to FIG. 7, graphical page masters 50′ for page forty-nine and page fifty-two of the given master key system are shown shaded in different colors. As can be seen therein, each graphical page master 50′ is divided from adjacent graphical page masters 50′ by a heavy dashed lined.

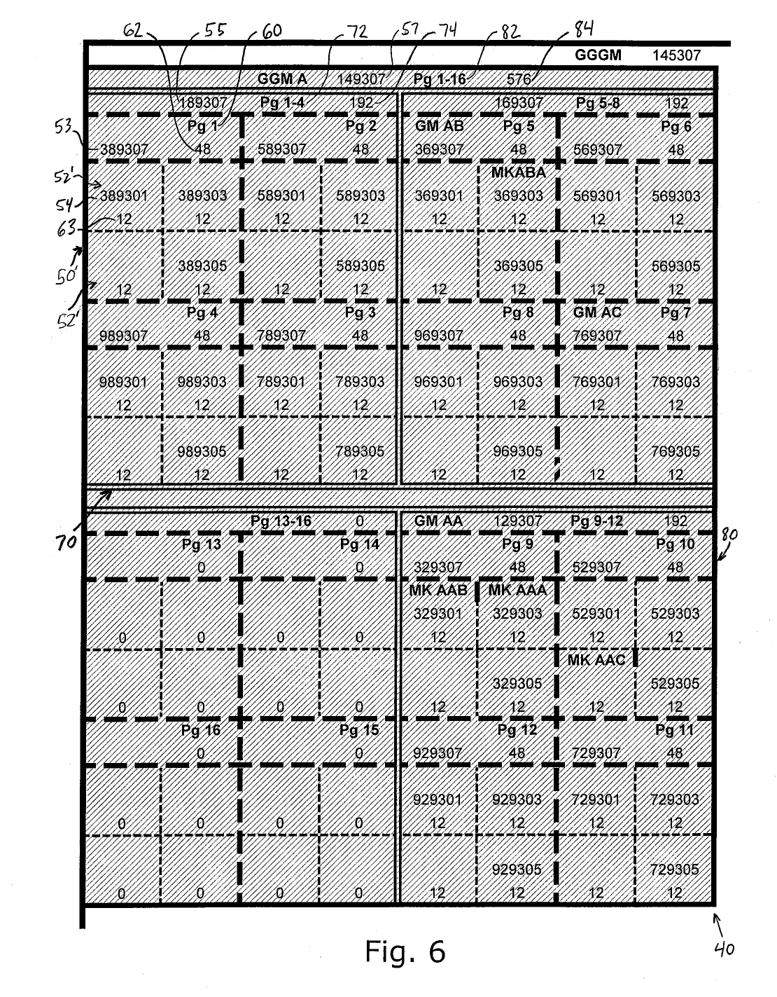

Turning to FIG. 6, graphical page master 50′, corresponding to page master 50 for page one as shown in FIG. 4, is shown. The graphical page master 50′ preferably includes an identifier 60 of the page, a listing of the page master key cut 53 and a total number of change key cuts 62 available under that page master key cut 53. In the preferred embodiment, each graphical page master 50′ is further divided by small dashes to illustrate each graphical vertical group 52′. Within each graphical vertical group 52′, the vertical group master key cut 54 is listed as well as the total number of change key cuts 63 available under that vertical group master key cut 54.

The master key illustrator 40 is further configured to show higher level master key availability. In this regard, graphical page masters 50′ for larger groups are arranged within master key illustrator 40 adjacent to one another. Referring to FIG. 6, the graphical page masters 50′ for pages one through four are all arranged within a larger rectangle, which is illustrated contained within double solid lines, to define a graphical four page group master 70. The graphical four page group master 70 preferably includes an identifier 72 of the pages, a listing of the four page group master key cut 55 and a total number of change key cuts 74 available under that four page group master key cut 55.

Similarly, the graphical page masters 50′ for pages one through sixteen are all arranged within a larger rectangle, which is illustrated contained within a single solid line, to define a graphical sixteen page group master 80. As illustrated in FIG. 5, the master key illustrator 40 includes four of the graphical sixteen page group masters 80. Referring again to FIG. 6, each graphical sixteen page group master 80 preferably includes an identifier 82 of the pages, a listing of the sixteen page group master key cut 57 and a total number of change key cuts 84 available under that sixteen page group master key cut 57.

Referring to FIG. 5, the master key illustrator 40 includes all of the graphical page masters 50′ arranged within an outer rectangle, which is illustrated contained within a single, thick solid line, to define a graphical top master 90. The illustrated graphical top master 90 includes four graphical sixteen page group masters 80 (single solid line), each of which is further divided into four graphical four page group masters 70 (double solid line), each of which is further divided into four graphical page masters 50′ (heavy dashed line), and each of which is further divided into four graphical vertical group masters 52′ (small dashed line). The graphical top master 90 preferably includes an identifier 92 of the pages, a listing of the top master key cut 59 and a total number of change key cuts 94 available under the top master key cut 59.

While the present master key illustrator 40 utilizes different line types to distinguish between the different levels, other indicators, for example, different line colors, can also be utilized. Additionally, as illustrated in FIGS. 5-7, a user may utilized different cell colors or shading to differentiate master keying levels or groupings for a desired project.

The mater key illustrator 40 allows a user to quickly see and determine if a selected master key system, as defined by the KBA, will provide a desired number of change keys and master keys and also the expandability of a given system. Utilizing shading or coloring of the cells can further help in the planning and specific implementation of the system.

For example, a university may want to determine if a master key system will be appropriate. In this example, the university includes a main dorm building with 500 rooms, two smaller dorms each with 150 rooms, a library with three areas of differing accessibility and two classroom buildings each with 35 classrooms. Turning to FIG. 5, the master key illustrator 40 may be utilized to determine if the master key system is the correct size, whether expansion is available and to plan the implementation of the system. Looking at the graphical top master 90, the system includes a total of 3,216 change key cuts. Within that, there are four graphical sixteen page group masters 80 with two of those having 960 change key cuts each, one having 720 change key cuts, and the other having 576 change key cuts. From this, the designer can quickly designate the graphical sixteen page group master 80 of pages one to sixteen as appropriate for the main dorm building.

Turning to the smaller buildings, the graphical sixteen page group master 80 of pages forty-nine to sixty-four has four graphical four page group masters 70. Within these, the graphical four page group master 70 for pages sixty-one to sixty-four has only 144 change key cuts, and therefore, will not work for either of the smaller dorms. However, since this graphical four page group master 70 does include three page masters 50′, each with an available master key cut, this graphical four page group masters 70 can be designated for the library. The user can quickly see that a fourth page master key is not available and can determine if such is or is not necessary for possible expansion.

As for the small dorms, the three remaining graphical four page group masters 70 each have 192 change key cuts available, and therefore, any two can be chosen for use with the respective dorms. The final graphical four page group master 70 includes four graphical page masters 50′, each with 48 change key cuts. Two of these graphical page masters 50′ can be chosen for the respective classroom buildings, leaving available expansion for two additional classroom buildings that could be keyed under the same four page group master key cut 55.

The user after shading the master key illustrator 40 as shown in FIG. 5, would also be able to see that after implementing the current design, there would still be plenty of room for expansion. The expansion could either be in fairly large blocks, for example, another large dorm of over 900 rooms (one of the sixteen page group masters) or smaller buildings have a need for sixty-four or less change keys (one of the page masters), down to smaller buildings yet needed sixteen or less change keys (one of the vertical group masters).

If upon review of the master key illustrator 40 the user determines that a given master key system is too larger or too small for its needs, a new KBA can be entered and a new master key illustrator 40 generated for the new master key system.

Additionally, a user with a current master key system may use the present system by entering information on the current master key system therein and generating a master key illustrator 40 for the current master key system to identify what master keys and change keys remain available in the current master key system.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of evaluating a master key system, the method comprising:
entering criteria for the master key system;
determining the available master key cuts and change key cuts based on the criteria and arranging the determined available master key cuts and change key cuts under a standard progression format including at least two page masters; and
displaying each page master as a graphical page master arranged graphically relative to the other graphical page masters based on a master key hierarchy.

2. The method of claim 1 wherein each graphical page master includes a page identifier and a listing of the total number of key cuts available under the page master key.

3. The method of claim 1 wherein each graphical page master is further divided into at least two graphical vertical groups.

4. The method of claim 1 wherein at least four graphical page masters are arranged adjacent one another and graphically group together to define a graphical four page group master, the graphical four page group master including an identifier of the four pages and a listing of the total number of key cuts available under a respective four page group master key.

5. The method of claim 4 wherein at least four graphical four page group masters are arranged adjacent one another and graphically group together to define a graphical sixteen page group master, the graphical sixteen page group master including an identifier of the sixteen pages and a listing of the total number of key cuts available under a respective sixteen page group master key.

6. The method of claim 5 wherein at least four graphical sixteen page group masters are arranged adjacent one another and graphically group together to define a graphical top master, the graphical top master including an identifier of the included pages and a listing of the total number of key cuts available under a respective top master key.

7. The method of claim 6 wherein each of the page masters are graphically distinguished from the graphical four page group masters which are graphically distinguished from the graphical sixteen page group masters which are graphically distinguished from the graphical top master.

8. The method of claim 7 wherein the masters are distinguished by line color or line type.

9. The method of claim 1 wherein each of the graphical page masters is configured to be shaded.

10. The method of claim 1 wherein the criteria includes at least a key bitting array and a sequence of progression.

11. The method of claim 1 wherein entry of new criteria automatically updates each graphical page master.

12. A master key illustrator for illustrating the available master key cuts and change key cuts under a master key system having a master key hierarchy, the illustrator comprising:
at least first and second graphical page masters, each graphical page master representative of a respective group of master key cuts and change key cuts available under the master key system,
wherein the graphical page masters are arranged graphically relative to the other graphical page masters based on the master key hierarchy.

13. The master key illustrator of claim 12 wherein each graphical page master includes a page identifier and a listing of the total number of key cuts available under the page master key.

14. The master key illustrator of claim 12 wherein each graphical page master is further divided into at least two graphical vertical groups.

15. The master key illustrator of claim 12 including at least four graphical page masters that are arranged adjacent one another and graphically grouped together to define a graphical four page group master, the graphical four page group master including an identifier of the four pages and a listing of the total number of key cuts available under a respective four page group master key.

16. The master key illustrator of claim 15 including at least four graphical four page group masters that are arranged adjacent one another and graphically grouped together to define a graphical sixteen page group master, the graphical sixteen page group master including an identifier of the sixteen pages and a listing of the total number of key cuts available under a respective sixteen page group master key.

17. The master key illustrator of claim 16 including at least four graphical sixteen page group masters that are arranged adjacent one another and graphically group together to define a graphical top master, the graphical top master including an identifier of the included pages and a listing of the total number of key cuts available under a respective top master key.

18. The master key illustrator of claim 17 wherein each of the page masters are graphically distinguished from the graphical four page group masters which are graphically distinguished from the graphical sixteen page group masters which are graphically distinguished from the graphical top master.

19. The master key illustrator of claim 18 wherein the masters are distinguished by line color or line type.

20. The master key illustrator of claim 12 wherein each of the graphical page masters is configured to be shaded.
